(19) United States
(12) Patent Application Publication
(10) Pub. No.: US 2008/0202167 A1
(43) Pub. Date: Aug. 28, 2008

(54) Thermal edge finishing

(76) Inventors: Nicholas Dominic Cavallaro, Corning, NY (US); Zung-Sing Chang, Horseheads, NY (US); Gautam Narendra Kudva, Horseheads, NY (US); Toshihiko Ono, Fukuroi-shi (JP); Ljerka Ukrainczyk, Painted Post, NY (US); Sam Samer Zoubi, Horseheads, NY (US)

Correspondence Address: CORNING INCORPORATED, SP-TI-3-1, CORNING, NY, 14831, US

(21) Appl. No.: 12/070,585

(22) Filed: Feb. 20, 2008

Related U.S. Application Data
(60) Provisional application No. 60/903,221, filed on Feb. 23, 2007.

(51) Int. Cl. C03B 25/02; C03B 33/03; B23K 26/073; B23K 26/40

(52) U.S. Cl. 65/104; 65/105; 219/121.68; 219/121.69

(57) ABSTRACT

A thermal edge finishing process includes preheating at least one cut edge of a glass sheet, laser finishing the edge to a single full continuous radius from a position orthogonal to the edge and in-plane with the glass sheet while continuing to heat the glass, and localized annealing of the edge to reduce residual stress from the laser/thermal treatment of the edge. By the present process, edge stress is reduced considerably, such as to less than 3000 psi, and more preferably to less than 2500 psi, and to as low as 1000 psi in the first 1 mm along the treated edge.

### CROSS-REFERENCE TO RELATED APPLICATIONS

This application claims the benefit of priority under 35 U.S.C. § 119(e) of U.S. Provisional Application Ser. No. 60/903,221 filed on Feb. 23, 2007.

### TECHNICAL FIELD

The present application relates to thermal edge finishing and annealing of glass sheet, and more particularly relates to laser finishing of an edge of glass sheet and subsequent annealing to reduce residual tensile stress along the edge thus reducing downstream defects and quality concerns.

### BACKGROUND

One known method for mechanical separation and finishing of glass sheet entails a cutting process such as mechanical scoring with a score wheel, and separation by crack propagation via bending of the glass sheet, and an edge finishing process such as grinding. Mechanical edge finishing is typically performed as a wet process. Mechanical scoring, separation, and edge finishing produce glass chips which adhere to the surfaces of the glass sheet. The glass sheets must then be washed to remediate the glass chip contamination of the glass sheet surfaces. This need to wash the glass sheet following the score, break and edge finishing processes adds cost to the manufacturing process, and it is therefore desirable to eliminate the cause of the contamination, i.e., mechanical score, break and edge finishing processes.

Mechanical edge finishing, which typically includes grinding and polishing steps, also introduces subsurface damage into the edge of the glass sheet. Subsurface damage, including unhealed cracks in the edge, causes weak points that lower the strength of the edge of the glass. The breakage of glass sheets typically stems from flaws on the edge of a sheet, so the stronger the edge (i.e., the fewer flaws), the lower the probability that a glass sheet will break during handling and processing. Edge strength is a statistical quantity measured using Weibull distribution, and the probability of breaking a sheet increases as the size of the sheet increases. Therefore, it is especially desirable to increase the edge strength (and decrease flaws and weak points along the edge) for very large sheets (e.g., with edges longer than about 1 m, 1.5 m or 2 m).

Methods to “clean cut” glass sheet are known, such as by using a laser for glass scoring and separation, and/or by using a laser for cutting glass. For example, see U.S. Pat. No. 6,713,730; U.S. Pat. No. 6,204,472; U.S. Pat. No. 6,327,875; U.S. Pat. No. 6,407,360; U.S. Pat. No. 6,420,678; U.S. Pat. No. 6,541,730; and U.S. Pat. No. 6,112,967. However, thermal processes (including the use of laser beams for glass scoring or glass cutting) generate high residual stresses in the glass because the glass is locally, i.e., near the edge, heated above its strain point during the scoring/separation. These residual edge stresses are undesirable as they can lead to breakage during subsequent handling, transport, and use. Further, they can limit or prevent downstream processing, such as cutting of the glass into smaller sizes, because the residual stresses can cause quality concerns such as unacceptable crack out and chipping. Radiant heaters can be used to reduce residual stresses via a localized heat treatment (annealing) process. The glass optical properties, infrared opacity, however, limit the stress relief that can be obtained from radiant heaters.

To summarize, the glass sheet obtained by a typical mechanical or laser scoring and separation process has a glass edge that is “square” and relatively sharp (FIG. 1). The “square” edge is undesirable and requires further finishing because the sharp corners (formed at the juncture line of the edge surface with each face surface) are high stress points which can easily be damaged by impact or friction. Such edge damage creates faults that can propagate a crack through the glass sheet when the glass is put into tension, and glass chips that can contaminate the glass surface. The traditional approach to reduce the risk of edge damage is to round the edges of the glass sheet by beveling the edges with a grinding wheel, which is a wet process that produces particles and contaminates the glass.

Laser edge finishing is a clean process, but laser finishing tends to induce high residual stress at the edge and could adversely affect the strength of the sheet. Hence, there are quality concerns in downstream processes when laser edge finishing is used.

Therefore, the need exists for a clean edge finishing process and apparatus for glass which does not introduce an unacceptable amount of residual tensile stress, flaws or defects along the edge.

### SUMMARY

The present invention relates to laser finishing of a cut edge of glass with pre-laser and post-laser operations combining to reduce residual tensile stress along the edge as compared to laser finishing without the pre and post operations. The present method also provides for a repeatable and uniform process that is compatible with both continuous and batch processes for making glass sheet of large and small sizes, and that can be used on glass sheet at room temperature or at an elevated temperature (such as a sheet heated in a furnace or lehr).

The present process is a clean and dry process, which requires no surface protection of the glass sheet, and no subsequent cleaning of the glass sheet. The resultant edge has a smooth polished finish, and is substantially free of subsurface damage. Thus, glass sheet processed with the present invention has a improved resistance to impact damage than glass sheet having mechanically ground and polished edges. In addition, glass sheet processed with the present invention has a increased resistance to failure under continuous loading than glass sheet having mechanically ground and polished edges and is substantially free of debris and particles. The present process makes it possible to achieve edges having residual tensile stresses below 3000 psi, and as low as 2500 psi, and even as low as 1000 psi, as discussed below.

In one embodiment of the present invention, a method of thermal edge finishing for finishing glass sheet having edges with sharp corners includes steps of heating at least one of the edges of the glass sheet to an elevated temperature, thermally treating the at least one edge with a laser beam to round and finish the same while at the elevated temperature, and annealing the at least one edge to reduce transient stresses generated during edge finishing.

In another embodiment of the present invention, a method of thermal edge finishing for finishing an edge of glass sheet comprises steps of preheating an edge of a glass sheet, laser finishing the edge to a non-sharp shape in a single pass with a laser device, and annealing the edge by heating the edge from sides of the edge as well as orthogonally from the edge.

In still another embodiment of the present invention, an apparatus for thermally finishing glass sheet having an edge includes at least one first heat source for heating the edge of the sheet, a laser device configured to produce a laser beam adapted to round and finish the edge to a single continuous, or full, radius, e.g., no “flat” spot, in a single pass while the edge is at an elevated temperature, and at least one second heat source for annealing the edge to reduce transient stresses generated during edge finishing by the laser device.

Additional features and advantages of the invention are set forth in the detailed description which follows, and, in part, will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely exemplary of the invention, and are intended to provide an overview or framework for understanding the nature and character of the invention as claimed below. Also, the above listed preferred and other embodiments of the invention discussed and claimed below, can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. It should be noted that the various features illustrated in the figures are not necessarily drawn to scale. In fact, the dimensions may be arbitrarily increased or decreased for clarity of discussion.

### BRIEF DESCRIPTION OF DRAWINGS

FIG. 1 is a side view of a glass sheet having cut edges with sharp corners.

FIGS. 1A, 1B and 1C are side views similar to FIG. 1, but showing the glass edges after laser edge treatment, the edge of FIG. 1A having a uniform or substantially radius, the edge of FIG. 1B having uniformly radiused corners joined by a flat, and the edge of FIG. 1C having two different radii connected by a flat.

FIG. 2 is a schematic perspective view showing laser treatment of an edge of the glass sheet.

FIG. 3 schematically shows a pattern created by a laser beam, FIG. 3 being a simple elliptically-shaped Gaussian beam, and FIG. 3A being a cross-sectional view.

FIGS. 3B and 3C schematically show patterns created by modified D-mode laser beams with 25/25/50 and 20/20/60 mixing of TEM10/TEM01/TEM00 modes, respectively.

FIG. 4 is a side cross-sectional view of an edge similar to an edge from FIG. 1A but showing slight mushrooming of edge material.

FIG. 5 is a flow chart showing the present process of preheating glass, laser treating edges of the glass, and annealing of the edge.

FIGS. 6, 6A, 6B, and 6C, are side views of heaters positioned around an edge of glass sheet, FIG. 6 showing a preheat step, FIG. 6A showing a laser treatment step while heating the edge, and FIGS. 6B and 6C showing alternative heater arrangements for annealing the edge(s) of the glass sheet. The heaters can be positioned and oriented to heat the at least one edge and generally positioned to limit heating of a remainder of the glass sheet.

FIG. 7 is a perspective view of a glass sheet with laser treated and adjacent annealed edges, the illustrated two edges joining at a ninety-degree corner of the glass sheet.

### DETAILED DESCRIPTION

In the following detailed description, for purposes of explanation and not limitation, example embodiments disclosing specific details are set forth in order to provide a thorough understanding of the present invention. It will be apparent to one having ordinary skill in the art having had the benefit of the present disclosure, however, that the present invention can be practiced in other embodiments that depart from the specific details disclosed herein. Moreover, descriptions of well-known devices, methods and materials may be omitted so as not to obscure the description of the present invention.

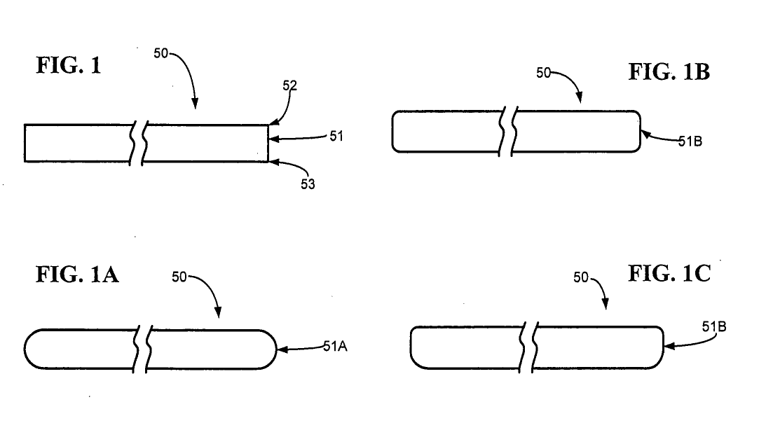

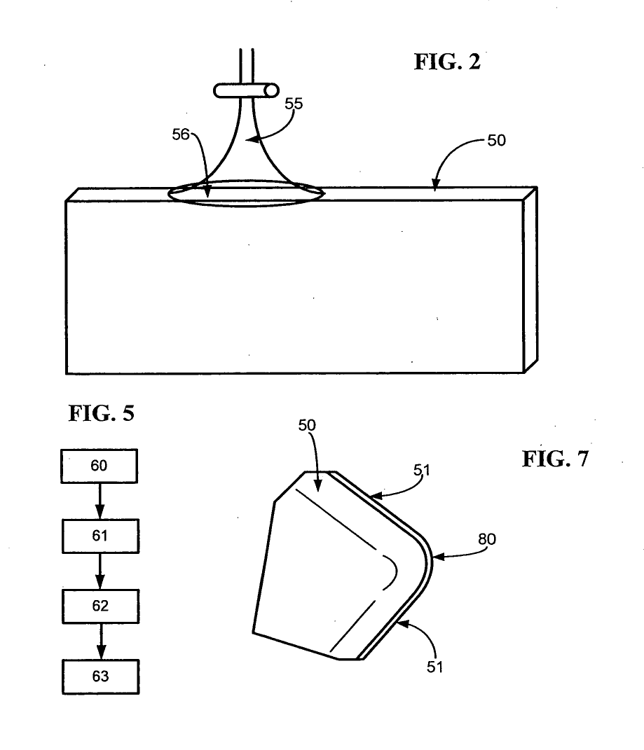

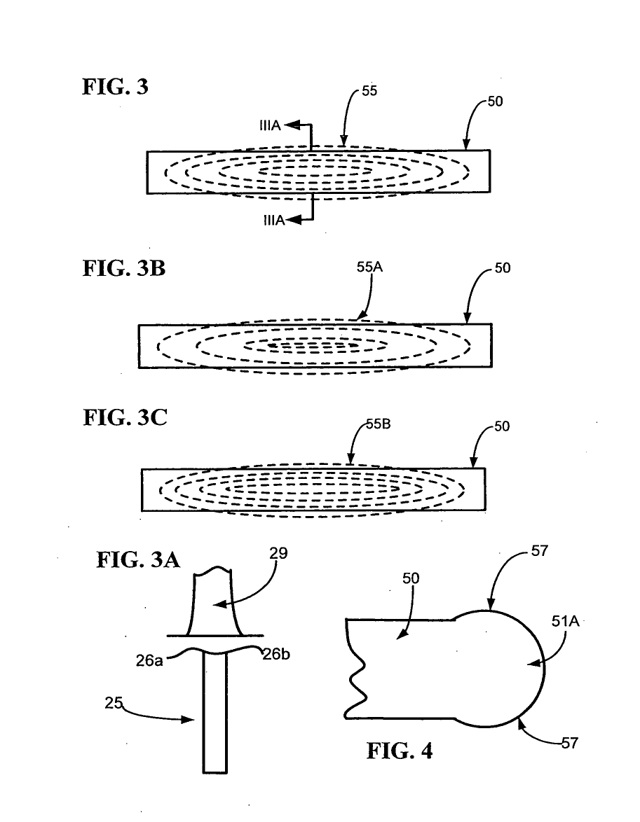

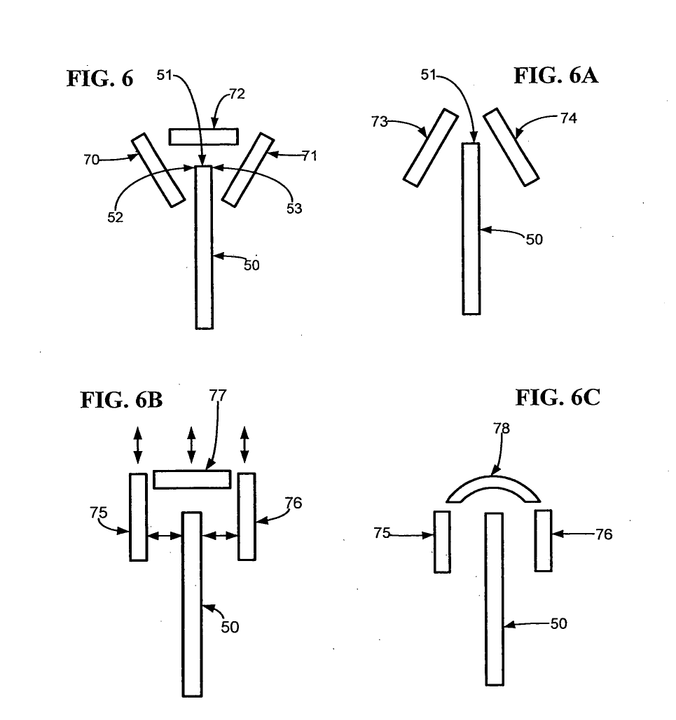

The present process includes providing a glass sheet 50 with at least one cut edge 51 (FIG. 1) having sharp corners 52 and 53, and rounding the edge using thermal edge finishing techniques (e.g., lasers) (FIGS. 2-3C) to form a uniformly radiused edge 51A (FIG. 1A), a symmetrical edge (such as the two-radius-with-flat edge 51B) (FIG. 1B), an asymmetric edge (such as FIG. 1C), or a parabolic or other shaped edge (not shown). In addition, it is contemplated that a center of curvature does not have to coincide with the center of the sheet edge 51. The present process further includes reducing the residual stress in the laser edge finished glass sheet by a localized pre-heating step prior to laser finishing (step 60), an optional localized heating step during laser finishing (step 61), and a localized heat treatment/annealing step following laser finishing (step 63) (FIGS. 5, 6 and 6A-6D).

Referring to FIG. 2 laser beam 55 which forms a laser pattern/spot 56 is positioned orthogonal to the edge of the glass sheet 50, with edges of the laser spot 56 extending beyond the edge of the glass sheet 50 to assure laser treatment even if the position of the edge of the glass sheet 50 varies. An elliptical shape of laser spot 56 is preferred over a round shape, because it provides for a higher process speed. It is contemplated that any beam profile, e.g., s-mode, d-mode, etc., can be used for edge finishing, although there are some advantages in modifying the beam shape from simple Gaussian beam for better process uniformity and stability. FIG. 3 shows the high peak power associated with the power distribution of a typical Gaussian beam. This results in higher stresses than other beam profiles and is less desirable. The elliptical shape of the beam 55 in FIG. 3 (and FIG. 3A) is obtained by expanding the beam laterally into an elliptical shape by well known methods, such as by using zinc selenide refractive optics and reflective optics. Those profiles are achievable in commercially available CO₂ lasers which can produce a D mode and Q mode. FIGS. 3B and 3C are elliptically-shaped D-mode beams 55A and 55B with 25/25/50 and 20/20/60 mixing of TEM10/TEM01/TEM00 modes, respectively. Another type of beam shape that would be advantageous is a D mode beam with a top hat profile to provide uniform heating across the beam width.

The glass sheet 50 is moved under the laser beam 55, and/or the laser beam 55 is traversed along the edge 51 of the glass sheet 50 by, e.g., using flying optics. If sufficient heat flux is applied to the edge 51, the glass melts and surface tension forces the flowing glass into a rounded edge, primarily in a direction perpendicular to a plane defined by the glass sheet 50. By controlling the input heat flux and residence time one can control the degree of rounding. Insufficient heating will result in insufficient rounding. Excessive heating can cause the glass to overflow a plane defined by the two surfaces that are perpendicular to the edge. This is referred to as mushrooming. The “mushrooming” 57 (FIG. 4) in the plane of the glass sheet 50 is minimal (less than 0.5 μm). Notably, the radius of the curvature can be adjusted by varying the process parameters such as laser power applied and residence time of the laser. Flux depends upon laser power, beam elongation and translational speed. For example, one can use a power of 200-600 W, or about 350 W, with an elongated beam of 40-100 mm or about a 60 mm, operating at a translational speed of about 60-150 mm/s, or about 100 mm/s. It is to be understood that an elongated beam is longer in a direction parallel to edge 51 than it is in a direction perpendicular to edge 51.

If the localized heating steps of the present invention, described more fully below, are not employed, the resultant edge treatment produces high localized stress in the first 1-2 mm from the glass edge 51 toward the center of glass sheet 50 (such as, e.g., greater than 5000 psi). Such high stress values tend to induce breakage in the edge.

Thus, the edge stress which otherwise would be created by the laser edge treatment described above is minimized by using the localized edge preheating and edge annealing (FIGS. 5 and 6-6C) steps of the present invention. First, the edge 51 is preheated to about 350° C. to about 450° C., or about 400° C. prior to laser edge finishing. Heating of the edge 51 and adjacent area, the adjacent area being that area of the sheet within about 75-150 mm or about 100 mm of the edge, is accomplished by an arrangement of heaters, such as side heaters 70 and 71 and, optionally, by an orthogonally-positioned end heater 72 (FIG. 6). Any suitable heater can be used, such as, e.g., IR radiant heaters with resistive heating elements or natural gas/air burners. The preheating step 60 minimizes the transient stress created by applying the laser beam 55 to the edge of the glass. After preheat, the edge 51 is laser-treated in step 61 by laser beam 55 while the glass sheet is at the elevated temperature (FIG. 6A). During laser treatment, side heaters 73 and 74 are optionally used to maintain an optimal temperature, e.g., holding the area adjacent to the edge to about 350° C. to about 450° C., or about 400° C., and optimal heat distribution or gradient of material at and around the edge 51.

After laser treatment, the glass sheet edge 51 is treated in an annealing step. The heaters in the annealing zone include opposing side heaters 75 and 76 and further include an end heater 78 orthogonally positioned in alignment with the edge 51, such as flat end heater 77 or arcuately-shaped end heater 78. The heaters 75-77 (or heaters 75, 76, and 78) form a concave, or enveloping, arrangement where glass temperature is closely and carefully controlled by a controller for optimal cool down. The optimal cool down rate will depend upon the glass′ CTE, glass transition temps, strain point, anneal point, young's modulus and the desired residual stress, and will be readily ascertainable by one of ordinary skill in the art. The edge 51 is annealed by controlling the cool down rate following the laser edge polishing. The localized edge annealing is achieved by using side heaters, top heaters, ribbon burners, and/or secondary laser heating of the glass sheet 50 and the width of the stress band. Localized heating generates localized areas of transient and hence residual stress. When you are done with this process, an area or “band” of residual stress is observed in the glass, and this is the stress band.

The peak stress at the edge is minimized by starting the annealing process at a temperature above the annealing point of the glass, and using a slow cool down rate, such as a cool down rate of less than about 130° C. to about 200° C., or about 150° C./minute. Notably, the heaters 70-72 and/or heaters 73-74 and/or the heaters 75-77 (and/or heaters 75, 76, 78) may be movably supported and/or the gas/air flow for burners and heat controlled for optimal temperature control during the preheat, the laser-treat and the annealing step in the process.

Stress magnitude in the finished product is determined by the ability to finish all four edges on a rectangular piece of glass, and the ability to pass a score test, where the glass is scored and separated without the edge breaking off along high stress line due to scoring pressure. Testing has shown that the present process of FIG. 5 can produce edges with less than 3000 psi, and more preferably less than 2500 psi residual tensile stress, and even less than 1100 psi residual tensile stress, based on readings using a commercially available device such as a DIAS-1600™ unit from StrainOptics, Inc. using standard operating procedures. The reference numerals in FIG. 5 have the following meaning:
60: Preheat glass with side and top heaters prior to applying laser beam;
61: Laser treat the edge while the entire edge is between side heaters at preheat temperature;
62: Move laser treated edge to localized heat zone to heat the edge above annealing point; and
63: Cool down the edge from a controlled cooling rate from annealing point to below strain point.

Notably, referring to FIG. 7, the laser polishing can be used to form a clean rounded corner 80 (a perspective view) where two finished edges meet on the sheet to form a radiused, or rounded 90° corner (radiuses being formed along the edges 51 and also at the “tip” or corner 80 formed by the joinder of the edges. Therefore, there is no need for a separate corner cut to round the corner of the sheet.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A method of edge finishing a sheet of brittle material, comprising steps of:
a) pre-heating an edge of the sheet to an elevated temperature;
b) further heating the pre-heated edge with a laser; and
c) annealing the edge to reduce residual stress.

2. The method of claim 1, wherein the step of pre-heating includes providing at least one heat source positioned and oriented to heat the at least one edge and generally positioned to limit heating of a remainder of the glass sheet.

3. The method of claim 1, wherein the step of pre-heating includes providing at least one heat source positioned orthogonally to and spaced from the at least one edge.

4. The method of claim 1, wherein the step of pre-heating includes heating the edge both prior to and during the step of heating the edge with a laser.

5. The method of claim 1, wherein the step of annealing includes providing a heat source focused on at least one side of the at least one edge.

6. The method of claim 5, wherein the step of annealing further includes providing heat sources on opposing sides of the at least one edge.

7. The method of claim 5, wherein the heat source comprises a radiant heater.

8. The method of claim 5, wherein the heat source comprises adjustable burners.

9. The method of claim 1, wherein the step of further heating the pre-heated edge with a laser further comprises focusing laser energy into a beam of substantially elliptical cross-section.

10. The method of claim 1, wherein the step of further heating the pre-heated edge with a laser results in the sheet edge having a single full radius extending from one side of the edge to another side of an edge.

11. The method of claim 1, wherein the step of further heating the pre-heated edge with a laser results in the edge having more than a single radius extending from a first surface of the sheet of brittle material to a second surface of the sheet of brittle material.

12. The method of claim 1, wherein the step of further heating the pre-heated edge with a laser comprises positioning a laser device orthogonally to the edge and in a same plane as defined by the glass sheet.

13. The method of claim 1, wherein the steps of pre-heating, further heating, and annealing are configured to reduce residual stress along the edge to below 3000 psi.

14. The method of claim 13, wherein the steps of pre-heating, further heating, and annealing are configured to reduce residual stress along the edge to below 2500 psi.

15. The method of claim 13, wherein the steps of pre-heating, further heating, and annealing are configured to reduce residual stress along the edge to below 1100 psi.

16. A method of thermal edge finishing for finishing an edge of glass sheet, comprising steps of:
a) pre-heating an edge of a glass sheet;
b) laser finishing the edge to a non-sharp shape in a single pass; and
c) heating the edge from opposing sides of the edge as well as orthogonally from the edge to anneal the edge.

17. The method of claim 16, wherein the step of laser finishing includes simultaneously laser finishing at least two edges of the glass sheet.

18. An apparatus for thermally finishing a glass sheet, comprising:
at least one first heat source for pre-heating an edge of the sheet;
a) a laser device configured to produce a laser beam adapted to round and finish the edge to a single continuous full radius; and
b) at least one second heat source for annealing the edge to reduce stresses generated during edge finishing by the laser device.

19. The apparatus of claim 18, wherein the at least one first heat source includes side heaters on opposite sides of the edge of the glass and an end heater positioned orthogonally to the edge.
